(19) United States
(12) Patent Application Publication
(10) Pub. No.: US 2013/0235792 A1
(43) Pub. Date: Sep. 12, 2013

(54) SYSTEMS AND METHODS FOR ESTABLISHING A CONNECTION SETUP THROUGH RELAYS

(71) Applicant: QUALCOMM INCORPORATED, San Diego, CA (US)

(72) Inventors: Santosh Paul Abraham, San Diego, CA (US); Simone Merlin, San Diego, CA (US); Zhi Quan, Livermore, CA (US); Alfred Asterjadhi, Breukelen (NL); Sameer Vermani, San Diego, CA (US)

(73) Assignee: QUALCOMM Incorporated, San Diego, CA (US)

(21) Appl. No.: 13/789,211

(22) Filed: Mar. 7, 2013

Related U.S. Application Data
(60) Provisional application No. 61/608,597, filed on Mar. 8, 2012.
(60) Provisional application No. 61/636,830, filed on Apr. 23, 2012.

(51) Int. Cl. H04W 88/04

(52) U.S. Cl. CPC H04W 88/04
USPC 370/315

(57) ABSTRACT

Systems, methods, and devices for securely communicating data are described herein. In some aspects, a station is configured to communicate with an access point. A relay includes an uncontrolled port and a controlled port. The relay is configured to forward association, authentication, and secure relay setup frames between the station and the access point through the uncontrolled port. The relay is configured to forward data packets between the station and the access point through the uncontrolled port once the station establishes a relay relationship with the relay.

### CROSS-REFERENCE TO RELATED APPLICATIONS

This application claims priority under 35 U.S.C. §119(e) to U.S. Provisional Patent Application No. 61/636,830, entitled “SYSTEMS AND METHODS FOR ESTABLISHING A CONNECTION SETUP THROUGH RELAYS” and filed on Apr. 23, 2012, the entire contents of which disclosure is herewith incorporated by reference. This application additionally claims priority under 35 U.S.C. §119(e) to U.S. Provisional Patent Application No. 61/608,597, entitled “SYSTEMS AND METHODS FOR ESTABLISHING A CONNECTION SETUP THROUGH RELAYS” and filed on Mar. 8, 2012, the entire contents of which disclosure is herewith incorporated by reference.

### BACKGROUND

1. Field

The present application relates generally to wireless communications, and more specifically to systems, methods, and devices for using a relay in a wireless communication network.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit/receive information between each other. In some aspects, the devices in the wireless network may have a poor connection and/or may not be able to communicate with each other. Thus, improved systems, methods, and devices for communicating in a wireless network are desired.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved communications between access points and stations in a wireless network.

One aspect of this disclosure provides a system for securely communicating data. The system comprises a station configured to communicate with an access point. The station further comprises a relay comprising an uncontrolled port and a controlled port. The relay may be configured to forward association, authentication, and secure relay setup frames between the station and the access point through the uncontrolled port. The relay may be configured to forward data packets between the station and the access point through the controlled port once the station establishes a relay relationship with the relay.

Another aspect of this disclosure provides a method for securely communicating data. The method comprises relaying, by a relay, association, authentication, and secure relay setup frames between a station and an access point through an uncontrolled port of the relay. The method further comprises relaying, by the relay, data packets between the station and the access point through a controlled port of the relay once the station establishes a relay relationship with the relay.

Another aspect of this disclosure provides an apparatus for securely communicating data. The apparatus comprises means for relaying association, authentication, and secure relay setup frames between a station and an access point through an uncontrolled port of the apparatus. The apparatus further comprises means for relaying data packets between the station and the access point through a controlled port of the apparatus once the station establishes a relay relationship with the apparatus.

Another aspect of this disclosure provides a non-transitory computer-readable medium comprising code that, when executed, causes an apparatus to relay association, authentication, and secure relay setup frames between a station and an access point through an uncontrolled port of the apparatus. The medium further comprises code that, when executed, causes an apparatus to relay data packets between the station and the access point through a controlled port of the apparatus once the station establishes a relay relationship with the relay.

### BRIEF DESCRIPTION OF THE DRAWINGS

FIG. 1 shows an exemplary wireless communication system in which aspects of the present disclosure may be employed.

FIG. 2 shows a functional block diagram of an exemplary wireless device that may be employed within the wireless communication system of FIG. 1.

FIG. 3A illustrates a wireless communications system comprising an access point, a station, and a relay.

FIG. 3B illustrates address fields of a data frame transmission between an access point and a relay and a station and the relay.

FIG. 3C illustrates a wireless communications system in which an access point and a station cannot directly communicate.

FIG. 3D illustrates address fields of a management frame transmission between an access point and a relay and a station and the relay.

FIG. 4A illustrates a timing diagram of a wireless communications system including an access point, a station, and a relay.

FIG. 4B illustrates a timing diagram of a wireless communications system including an access point, a station, and a relay.

FIG. 5 illustrates a relay initiator frame.

FIG. 6 is a flowchart of a process for selecting a relay in the wireless communications system of FIGS. 1 and 3A-D.

FIG. 7 is a functional block diagram of an exemplary device that may be employed within the wireless communication system of FIGS. 1 and 3A-D.

FIG. 8 is a flowchart of a process for selecting a relay in the wireless communications system of FIGS. 1 and 3A-D.

FIG. 9 is another functional block diagram of an exemplary device that may be employed within the wireless communication system of FIGS. 1 and 3A-D.

FIG. 10 is a flowchart of a process for registering a relay in the wireless communications system of FIGS. 1 and 3A-D.

FIG. 11 is another functional block diagram of an exemplary device that may be employed within the wireless communication system of FIGS. 1 and 3A-D.

FIG. 12 is a flowchart of a process for discovering a wireless communications system of FIGS. 1 and 3A-D.

FIG. 13 is another functional block diagram of an exemplary device that may be employed within the wireless communication system of FIGS. 1 and 3A-D.

FIG. 14 is a flowchart of a process for selecting a relay in the wireless communications system of FIGS. 1 and 3A-D.

FIG. 15 is another functional block diagram of exemplary devices that may be employed within the wireless communication system of FIGS. 1 and 3A-D.

FIG. 16 is a flowchart of a process for selecting a relay in the wireless communications system of FIGS. 1 and 3A-D.

FIG. 17 is another functional block diagram of exemplary devices that may be employed within the wireless communication system of FIGS. 1 and 3A-D.

FIG. 18 is a flowchart of a process for communicating using an amplify and forward relay in the wireless communications system of FIGS. 1 and 3A-D.

FIG. 19 is another functional block diagram of an exemplary device that may be employed within the wireless communication system of FIGS. 1 and 3A-D.

FIG. 20 is a flowchart of a process for setting up an amplify and forward relay in the wireless communications system of FIGS. 1 and 3A-D.

FIG. 21 is another functional block diagram of an exemplary device that may be employed within the wireless communication system of FIGS. 1 and 3A-D.

FIG. 22 illustrates a link identifier element.

FIG. 23 illustrates a tunneled encrypted data frame.

FIG. 24 illustrates another wireless communications system.

FIG. 25 illustrates a messaging timeline for frames that may transmitted in the wireless communications system of FIG. 24.

FIG. 26 illustrates another messaging timeline for frames that may transmitted in the wireless communications system of FIG. 24.

FIG. 27 is a flowchart of a process for securely communication data in the wireless communications system of FIGS. 1, 3A-D, and 24.

FIG. 28 is a functional block diagram of an exemplary device that may be employed within the wireless communication system of FIGS. 1, 3A-D, and 24.

### DETAILED DESCRIPTION

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol such as 802.11ah) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement the 802.11ah standard, for example. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

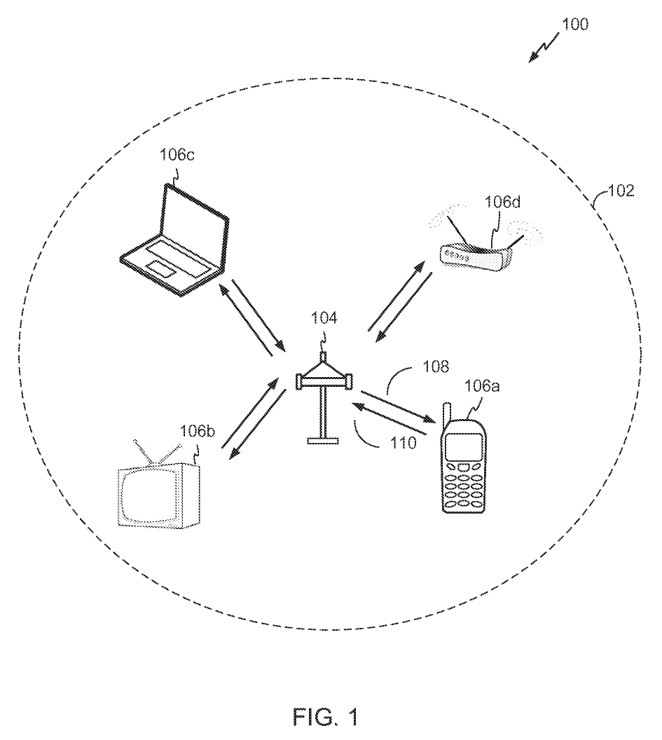

FIG. 1 shows an exemplary wireless communication system 100 in which aspects of the present disclosure may be employed. The wireless communication system 100 may operate pursuant to a wireless standard, for example the 802.11ah standard. The wireless communication system 100 may include an AP 104, which communicates with STAs 106.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

The AP 104 may transmit a beacon signal (or simply a “beacon”), via a communication link such as the downlink 108, to other nodes STAs 106 of the system 100, which may help the other nodes STAs 106 to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information both common (e.g. shared) amongst several devices, and information specific to a given device.

In some aspects, a STA 106 may be required to associate with the AP 104 in order to send communications to and/or receive communications from the AP 104. In one aspect, information for associating is included in a beacon broadcast by the AP 104. To receive such a beacon, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe or request, to the AP 104. In some aspects, the AP 104 may use backhaul services, for example, to communicate with a larger network, such as the Internet or a public switched telephone network (PSTN).

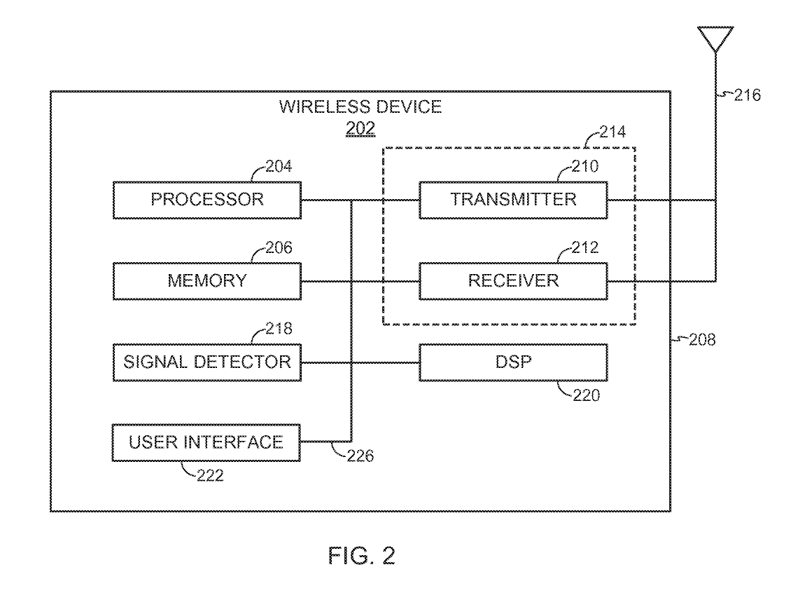

FIG. 2 shows an exemplary functional block diagram of a wireless device 202 that may be employed within the wireless communication system 100 of FIG. 1. The wireless device 202 is an example of a device that may be configured to implement the various methods described herein. For example, the wireless device 202 may comprise the AP 104, one of the STAs 106, or one of the relays 320 and/or 330.

The wireless device 202 may include a processor 204 which controls operation of the wireless device 202. The processor 204 may also be referred to as a central processing unit (CPU). Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a packet for transmission. In some aspects, the packet may comprise a physical layer data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

The wireless device 202 may comprise an AP 104, an STA 106, a relay 320, and/or an association relay 330, and may be used to transmit and/or receive communications. That is, either AP 104, STA 106, relay 320, or association relay 330 may serve as transmitter or receiver devices. Certain aspects contemplate signal detector 218 being used by software running on memory 206 and processor 204 to detect the presence of a transmitter or receiver.

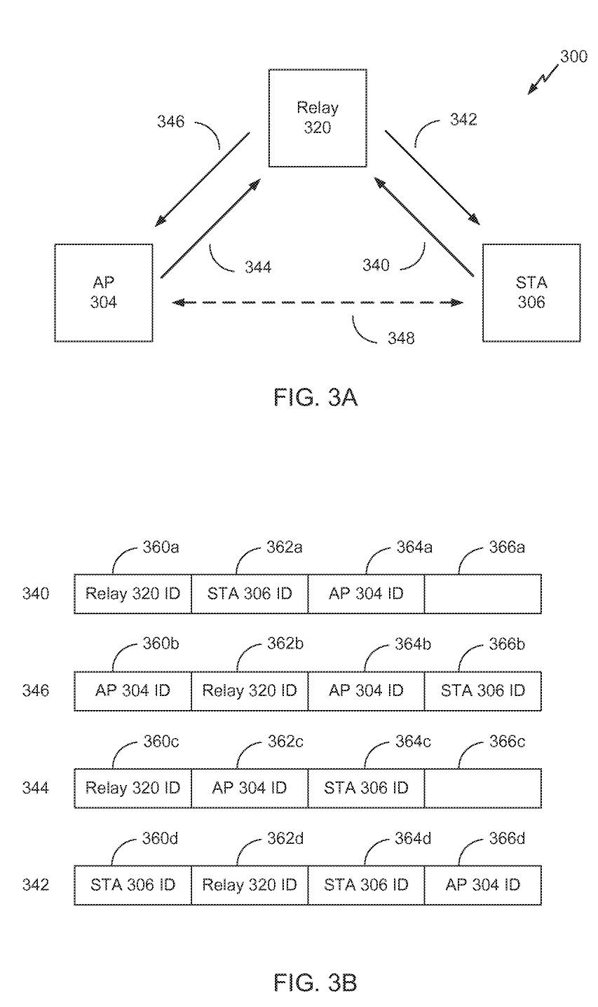

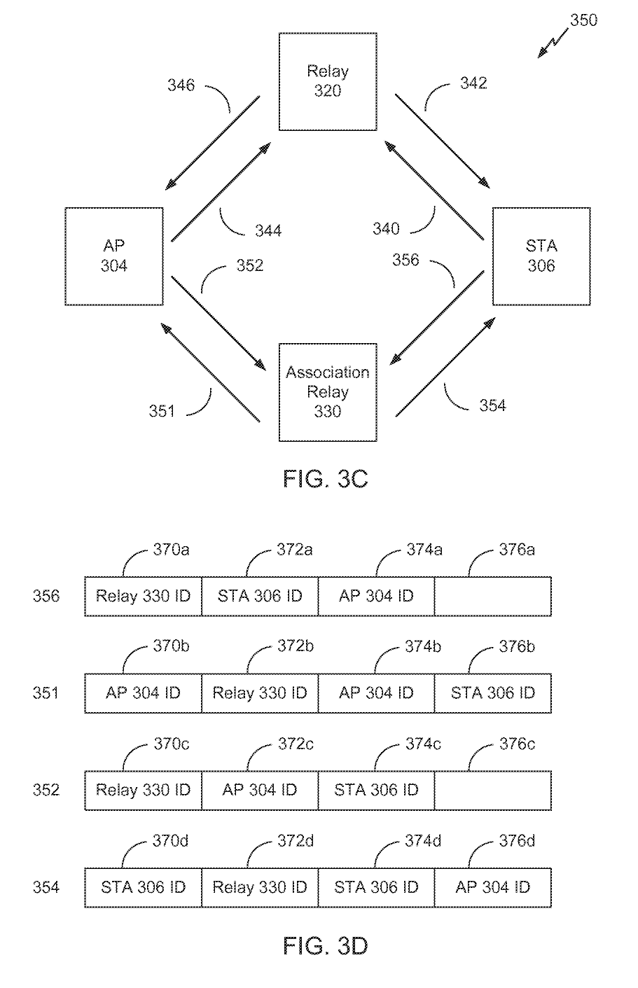

In some embodiments, AP 104 and STA 106 may not be able to communicate properly with each other. For example, AP 104 and STA 106 may be able to communicate with each other, but at a lower than desired data rate. In another example, AP 104 and/or STA 106 may be out of a transmit range of the other such that AP 104 and STA 106 cannot communicate with each other. Another device, such as a relay, may be utilized to form a bridge between the AP 104 and the STA 106 such that they can communicate properly with each other. For example, a store and forward relay may receive messages from the AP 104 and/or STA 106, determine an intended recipient of the messages, and forward the messages to the intended recipient. Store and forward relays may reduce median packet transmit times by half. As another example, an amplify and forward relay may receive messages from the AP 104 and/or STA 106 and immediately retransmit the received messages such that the intended recipient receives the messages. Amplify and forward relays may provide network throughput improvement by allowing for higher modulating and coding schemes (MCS) transmission rates while reducing or avoiding the overhead time associated with transmitting a frame twice. Relays, such as the store and forward relay and the amplify and forward relay, are described in greater detail herein with respect to FIGS. 3A-17.

FIG. 3A illustrates a wireless communications system 300 comprising an AP 304, a STA 306, and a relay 320. Note that while only one STA 306 and only one relay 320 are illustrated, the wireless communications system 300 may comprise any number of STAs and relays. In some embodiments, the AP 304 and the STA 306 can communicate with each other via the UL/DL transmission 348. However, the AP 304 and the STA 306 may have a poor connection. For example, the physical data rate may be limited to the lowest modulation and coding schemes (MCS). In other embodiments, the AP 304 and the STA 306 cannot communicate with each other via the UL/DL transmission 348.

### Store and Forward Relays

In certain aspects, if the AP 304 and the STA 306 have a poor connection or cannot communicate via the UL/DL transmission 348, a relay, such as the relay 320, may be set up to facilitate communication between the AP 304 and the STA 306. For example, the relay 320 may be a store and forward relay.

Before the relay 320 may facilitate communication between the AP 304 and the STA 306, the relay 320 may register or associate with the AP 304. During the association, the relay 320 may inform the AP 304 of its capabilities in, for example, a capabilities information field. The capabilities of the relay 320 may include a maximum number of STAs it supports, whether it is a relay for uplink traffic, downlink traffic, or both, or other relevant information for an AP 304 to determine whether it should consider the relay 320 as a suitable relay when it receives a probe request or request for relay connection from a STA. In this way, upon receiving a request for a relay by a STA, the AP can determine the appropriate relays to contact based on the information provided by the relays.

In those embodiments in which the AP 304 and the STA 306 have a poor connection, the STA 306 may associate with the AP 304 in any way known in the art. During the association process, the STA 306 may obtain an association identification from the AP 304. Once the association process is complete, the STA 306 may transmit to the AP 304 a request for relay connection. In an embodiment, the request for relay connection may include the capabilities of the STA 306. For example, capabilities of the STA 306 may include its transmit range, a maximum and/or a minimum data rate, a type of data the STA 306 transmits, or the like.

Once the AP 304 receives the request for relay connection, the AP 304 may instruct one or more relays, such as relay 320 and other relays (not shown), to transmit to the STA 306 a setup response frame. The instructions may include the capabilities of the STA 306 and/or the media access control (MAC) address of the STA 306. In an embodiment, the setup response frame may be a tunneled direct link setup (TDLS) response frame. Generally, TDLS communications allow for direct communication between STAs in a wireless communications network. The reuse of the TDLS protocol in establishing a connection between a STA and a relay in a wireless communications system may be advantageous since TDLS defines a security protocol, which can be repurposed for securing a link between the relay 320 and the STA 306. The reuse of the TDLS protocol may also be advantageous because it defines how and when the two communicating entities enter and exit a power saving mode. In this way, the reuse of the TDLS protocol may allow for secure connections and power savings.

In an embodiment, the STA 306 may receive one or more setup response frames from one or more relays. The STA 306 may choose one of the relays that it received a setup response frame from to serve as its communications bridge with the AP 304. For illustration purposes only, FIG. 3A depicts STA 306 as choosing relay 320. The STA 306 may send a setup confirm frame to the chosen relay 320. In an embodiment, the setup confirm frame may be a TDLS confirm frame. The STA 306 may base the selection on any number of metrics, including the relay's link quality between itself and the AP 304, the link quality between the relay and the STA 306, whether the relay transmits uplink messages, downlink messages, or both, the transmit range of the relay, or the like.

In some embodiments, once the STA 306 has transmitted the setup confirm frame, the STA 306 informs the AP 304 about which relay was selected by the STA 306. Note that the STA 306 may not need to rely on the selected relay 320 to inform the AP 304, and instead may directly communicate with the AP 304. In other embodiments, once the STA 306 has transmitted the setup confirm frame, the selected relay 320 informs the AP 304 that it has been selected by the STA 306. The message informing the AP 304 that the relay 320 has been selected by the STA 302 may include a MAC address of the relay 320.

Note that in order for relay setup to occur, additional messaging may be defined and utilized in the relay setup protocol, as described herein. For example, a new category of action frames may be defined as “Relay Setup.” The category “Relay Setup” may initially include three action fields, where the first action field defines the request for relay connection transmission, the second action field defines the AP 304 instruction for the relays to transmit a setup response frame transmission, and the third action field defines the transmission used to inform the AP 304 that the relay 320 has been selected by the STA 306.

For transmissions 340 from the STA 306 to the relay 320, the data frames transmitted may contain MAC headers including three address fields. For transmissions 342 from the relay 320 to the STA 306, the data frames transmitted may contain MAC headers including four address fields. For transmissions 344 from the AP 304 to the relay 320, the data frames transmitted may contain MAC headers including three address fields. For transmissions 346 from the relay 320 to the AP 304, the data frames transmitted may contain MAC headers including four address fields.

FIG. 3B illustrates the address fields of the data frame transmissions between the AP 304 and the relay 320 and the STA 306 and the relay 320. Generally, the first address field 360a-d identifies an immediate destination of the packet, the second address field 362a-d identifies the immediate originator of the packet, the third address field 364a-d identifies the final destination of the packet, and the fourth address field 366a-d identifies the initial originator of the packet. For example, transmissions 340 may contain MAC headers including three address fields 360a, 362a, and 364a. Because the STA 306 is the immediate (and initial) originator of a packet that is immediately intended for the relay 320 and ultimately intended for the AP 304, address field 360a includes an identification of the relay 320, address field 362a includes an identification of the STA 306, and address field 364a includes an identification of AP 304 (e.g., the basic service set identification (BSSID)). Note that in some embodiments, the MAC headers may contain a fourth address field 366a, but the address field will be empty. In some aspects, the fourth address field may be left empty because the relay 320 is not the final destination of the packet, and by address fields 362a and 364a, the relay 320 is already aware of which STA transmitted the packet and which AP the packet is intended for.

Likewise, transmissions 346 may contain MAC headers including four address fields 360b, 362b, 364b, and 366b. In some aspects, transmissions 346 may be thought of as a continuation of transmissions 340. The relay 320 is the immediate originator of the packet, but the initial originator of the packet is the STA 306. The packet is immediately and ultimately intended for the AP 304. Accordingly, address field 360b includes an identification of the AP 304, address field 362b includes an identification of the relay 320, address field 364b includes an identification of the AP 304, and address field 366b includes an identification of the STA 306.

Transmissions 344 may contain MAC headers including three address fields 360c, 362c, and 364c. Because the AP 304 is the immediate (and initial) originator of a packet that is immediately intended for the relay 320 and ultimately intended for the STA 306, address field 360c includes an identification of the relay 320, address field 362c includes an identification of the AP 304, and address field 364c includes an identification of the STA 306. Like with transmission 340, in some embodiments, the MAC headers may contain a fourth address field 366c, but the address field will be empty. In some aspects, the fourth address field may be left empty because the relay 320 is not the final destination of the packet, and by address fields 362c and 364c, the relay 320 is already aware of which AP transmitted the packet and which STA the packet is intended for.

Likewise, transmissions 342 may contain MAC headers including four address fields 360d, 362d, 364d, and 366d. In some aspects, transmissions 342 may be thought of as a continuation of transmissions 344. The relay 320 is the immediate originator of the packet, but the initial originator of the packet is the AP 304. The packet is immediately and ultimately intended for the STA 306. Accordingly, address field 360d includes an identification of the STA 306, address field 362d includes an identification of the relay 320, address field 364d includes an identification of the STA 306, and address field 366d includes an identification of the AP 304.

In those embodiments in which the AP 304 and the STA 306 cannot communicate with each other, one or more relays may handle the association and network management as well as the data transmission. FIG. 3C illustrates a wireless communications system 350 in which the AP 304 and the STA 306 cannot directly communicate. For example, the AP 304 and the STA 306 may not be able to directly communicate because the STA 306 transmit power may be too low to reach the AP 304. Wireless communications system 350 may include AP 304, STA 306, relay 320, and association relay 330. Note that in some embodiments, the functionality of relay 320 and association relay 330 described herein may be performed by a single relay. Note also that for the purposes of simplicity, only one STA and only two relays are illustrated in FIG. 3C. However, wireless communications system 350 may include any number of STAs and relays.

The STA 306 may be able to discover the basic service set (BSS) through relays. In some embodiments, a relay, such as association relay 330, may respond to probe requests (via a probe response frame) transmitted by STAs that are sent to a wildcard service set identifier (SSID) or to the BSSID of the BSS that the association relay 330 operates in. In other embodiments, the association relay 330 may transmit messages to passively scan for STAs. The probe response frames and/or the messages transmitted by the association relay 330 may contain information elements that identify itself as a relay. In addition, the probe response frames and/or the messages may include information regarding the AP 304 that the association relay 330 is associated with (such as the SSID of the AP 304) and information regarding the capabilities of the association relay 330, which may include a link quality (i.e., an air link quality) that the association relay 330 shares with the AP 304.

Note that in some embodiments, the probe request transmitted by STA 306 may include additional parameters that the association relay 330 may use to determine whether to respond to the request. For example, the request may include information on whether the STA 306 wants a response only from an AP 304 or from either an AP 304 or any relays, such as association relay 330. The request may also include an identification of minimum capabilities desired by the STA 306, an identification of security parameters desired by the STA 306, identification of power save modes desired by the STA 306, and/or an identification of a link quality level (i.e., an air link quality level) that the STA 306 would like between the association relay 330 and the AP 304.

Note also that even if STA 306 cannot communicate with AP 304, the STA 306 may still be able to receive beacon messages from the AP 304. The beacon messages from the AP 304 may include information on which, if any, relays are associated with the AP 304. The beacon messages may further include an address of associated relays and metrics of air link quality. In some embodiments, the STA 306 may use the information in the beacon message transmitted by the AP 304 to determine whether it wants to search for a relay for that particular SSID. For example, the metrics of air link quality may allow the STA 306 to send unicast probe requests directly to a chosen relay(s). The STA 306 may also use the information in the beacon message to decide whether to request a relay via the request for relay connection message, or roam to another AP.

Once the BSS has been discovered through the association relay 330, the STA 306 can begin the process of associating with the AP 304 through the association relay 330. The association can take place in any way known in the art, but the association relay 330 may serve to bridge the communication between the STA 306 and the AP 304. In other words, the association relay 330 may receive management frames from the STA 306 and forward those to the AP 304, and vice versa, so that the STA 306 can associate with the AP 304.

Like the data frames described with respect to FIG. 3B, the management frames may contain four address fields. FIG. 3D illustrates the address fields of the management frame transmissions between the AP 304 and the association relay 330 and the STA 306 and the association relay 330. The address fields 370a-d, 372a-d, 374a-d, and 376a-d of the management frames are set in a similar manner as the address fields 360a-d, 362a-d, 364a-d, and 366a-d of the of the data frames. In this way, the STA 306 can successfully associate with the AP 304 and the AP 304 can identify the exact STA 306 that is attempting to associate with it.

Once the association is complete, the association relay 330 can be used to handle the relay selection and the TDLS response and confirm frames as described herein and with respect to FIGS. 3A-B. In other words, the association relay 330 may serve as a conduit, forwarding messages from the STA 306 to the AP 304 in the relay selection process described herein with respect to FIGS. 3A-B. For example, the association relay 330 may receive the request for relay connection from the STA 306 and forward this request to the AP 304. The AP 304 may then instruct other relays associated with the AP 304 to transmit the setup response frame. The STA 306 may then inform the association relay 330 of the relay it selected. The association relay 330 and/or the selected relay 320 may separately inform the AP 304 of which relay the STA 306 selected.

Note that in some embodiments, the association relay 330 is not the relay that the STA 306 selects to relay data transmissions. For example, as illustrated in FIG. 3C, the STA 306 selects relay 320 for data transmissions and communicates with the relay 320 as is described herein with respect to FIGS. 3A-B. In other embodiments, not shown, the association relay 330 is the relay that the STA 306 selects. Once the association and selection process is complete, the STA 306 communicates with the association relay 330 for data transmissions as is described herein with respect to FIGS. 3A-B.

In alternative embodiments, the management frames may include three address fields. The management frames, however, may include an indication, such as a one bit indication, that indicates when the frame is to be relayed to the AP 304. For example, the STA 306 may include a high indication when it wants the association relay 330 to forward the frame to the AP 304. The STA 306 may include a low indication when it does not want the association relay 330 to forward the frame to the AP 304.

Note that in general, if the AP 304 assigns AIDs, then a relayed frame may carry the AID of the STA 306 rather than the full address of the STA 306. Note also that to reduce the likelihood of collisions, there may be a reserved period of time for relays to accept transmissions from STAs. The reserved period of time may be the same for all relays or different per relay.

### Amplify and Forward Relays

In other aspects of the disclosure, relay 320 may be an amplify and forward relay. As described herein, an amplify and forward relay may reduce overhead because a packet received by the relay 320 would not need to be decrypted once received, and then re-encrypted when the packet is relayed. The amplify and forward relays may be useful when the STA 306 and the AP 304 can communicate with each other directly, albeit poorly, or when the STA 306 can communicate with the AP 304 via another relay, such as a store and forward relay.

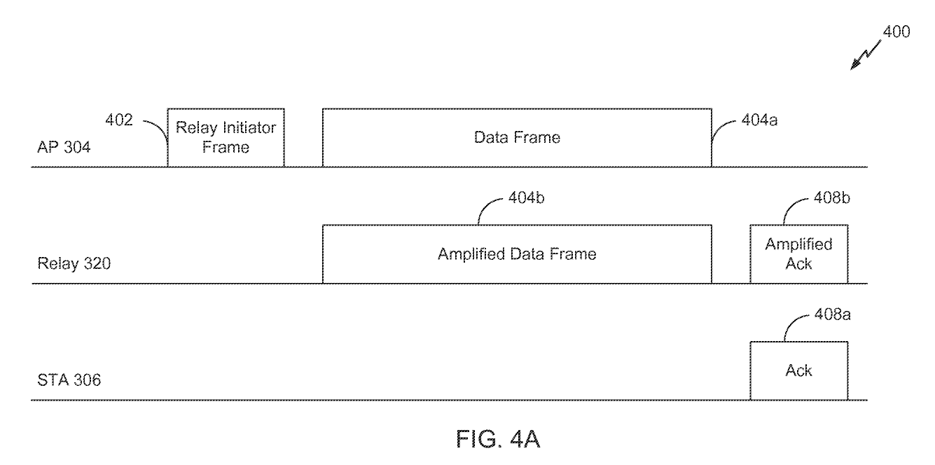

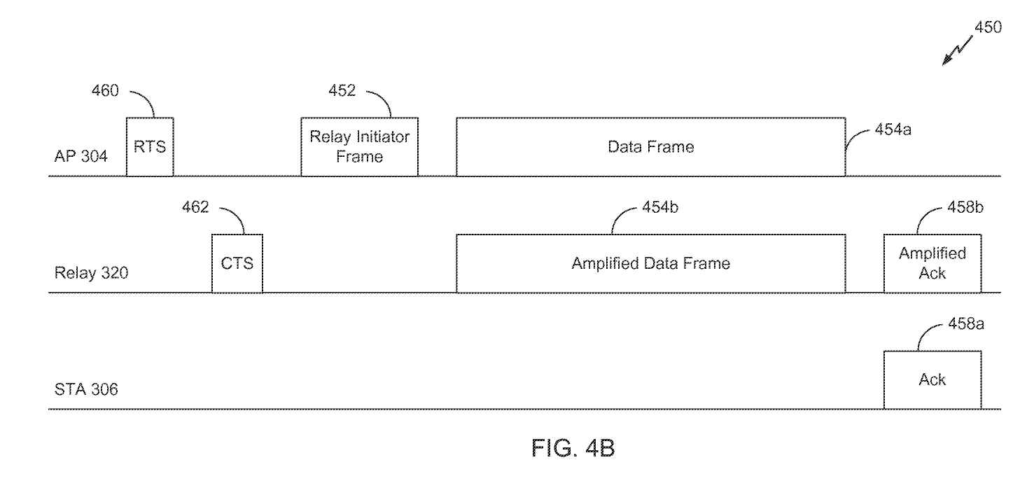

FIG. 4A illustrates a timing diagram 400 of a system including the AP 304, the STA 306, and the relay 320, where the relay 320 is an amplify and forward relay and all three devices communicate over a channel. In an embodiment, the AP 304 generates a relay initiator frame (RIF) 402 for transmission to the relay 320. In general, the RIF 402 may be addressed to a particular relay. As illustrated in FIG. 4A, the RIF 402 is addressed to the relay 320. After transmitting the RIF 402, the AP 304 may wait a duration equal to or nearly equal to a short interframe space (SIFS) before transmitting a data frame 404a. Receipt of the RIF 402 may cause the relay 320 to transmit an amplified version of any signal it detects on the channel, such as the amplified data frame 404b illustrated in FIG. 4A. The relay 320 may transmit an amplified version of any signal it detects on the channel at a same or substantially same time as the time that the relay 320 receives or detects the signal on the channel. For example, the relay 320 may transmit the amplified data frame 404b as a same or substantially same time as the time that the relay 320 receives the data frame 404a. Note that there may be some time delay between the receiving of data frame 404a and the transmitting of amplified data frame 404b due to the inherent latency of relay 320. In an embodiment, the relay 320 may transmit an amplified version of any signal it detects on the channel after waiting a duration equal to or nearly equal to the SIFS following the transmission of the RIF 402.

The STA 306 may receive the amplified data frame 404b transmitted by the relay 320. After waiting a period, such as a SIFS duration, the STA 306 may transmit an acknowledgement 408a. The relay 320 may receive the acknowledgment 408a and transmit an amplified version of the acknowledgment, amplified acknowledgment 408b. Likewise, if the relay 320 receives any other signals following the RIF 402 and following a SIFS duration, the relay 320 may transmit an amplified version of that signal as well. In an embodiment, a duration from the time the RIF 402 transmission ends to the time the acknowledgment 408a and amplified acknowledgment 408b transmission ends may be equal to a network allocation vector (NAV) of the RIF 402.

In some embodiments, the relay 320 may concurrently operate a packet detector to detect packets on the channel. If the relay 320 determines that the channel is idle, the relay 320 may cease transmitting, even if a RIF 402 has been received and a SIFS duration has passed.

While FIG. 4A illustrates the AP 304 transmitting the RIF 402, this is not meant to be limiting. The relay 320 may also receive a RIF from the STA 306 and perform the same operations as described herein. For example, the relay 320 may receive a RIF from the STA 306 and amplify a data frame transmitted by the STA 306. Likewise, the relay 320 may amplify an acknowledgment transmitted by the AP 304.

FIG. 4B illustrates a timing diagram 450 of a system including the AP 304, the STA 304, and the relay 320, where the relay 320 is again an amplify and forward relay and all three devices communicate over a channel. In some embodiments, prior to transmitting the RIF 452, the AP 304 may transmit a request to send (RTS) 460 message over the channel and addressed to the relay 320. If the channel is idle or the relay 320 otherwise determines a data transmission is acceptable, the relay 320 may respond by transmitting a clear to send (CTS) 462 message back to the AP 304. Once the AP 304 receives the CTS 462 message, it may operate as discussed above with respect to FIG. 4A.

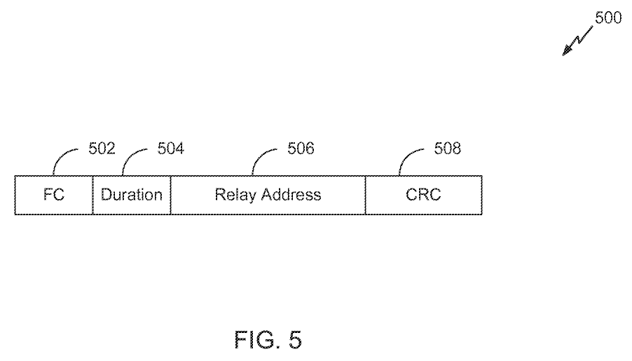

FIG. 5 illustrates a RIF frame 500, such as may be included in RIF 402 of FIGS. 4A-B. RIF frame 500 may include four fields: frame control (FC) 502, duration 504, relay address 506, and cyclic redundant check (CRC) 508. As an example, the FC 502 field may be 2 octets in length and may be used as is known in the art. Duration 504 may be 2 octets in length and may be set to the duration that encompasses the data packet transmission and the acknowledgment. Relay address 506 may be set to the address of a relay to which the RIF frame 500 is directed and may be 6 octets in length. The CRC 508 field may be 4 octets in length.

Note that in order for relay setup to occur, additional messaging may be defined and utilized in the relay setup protocol, as described herein. For example, as described herein, a new category of action frames may be defined as “Relay Setup” and include three initial action fields. For amplify and forward relays, the category “Relay Setup” may include six additional action fields. The fourth action field may define a request for an amplify and forward relay connection transmitted by the STA 306 to the AP 304. The fifth action field may define an AP 304 request (such as a discovery request frame) to the amplify and forward relays to transmit a discovery message to the STA 306. The request may include the address of the STA 306 and may be unicast, broadcast and/or group addressed. The sixth action field may define a discovery message transmitted from the amplify and forward relays to the STA 306. The discovery message may include a metric of the AP 304 to relay link (i.e., a quality of the air link between the AP 304 and the given amplify and forward relay). Note that the STA 306 may eventually choose an amplify and forward relay based on this metric and the link quality (i.e., air link quality) between itself and the amplify and forward relay. The seventh action field may define a message from the STA 306 to the AP 304 informing the AP 304 of which amplify and forward relay was selected by the STA 306. The message may include a MAC address of the selected amplify and forward relay. The eight action field may define a message from the STA 306 to the AP 304 informing the AP 304 that the STA 306 will no longer be using the selected relay. The ninth action field may define a message from the selected relay to the AP 304 informing the AP 304 that the STA 306 has been removed from its “relay services” (e.g., the selected relay will no longer be forwarding messages between the AP 304 and the STA 306).

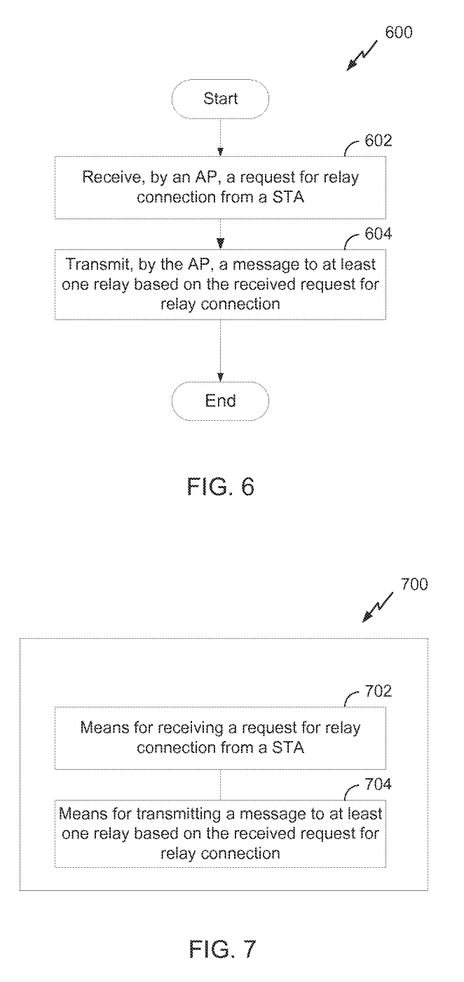

FIG. 6 is a flowchart of a process 600 for selecting a relay in the wireless communications system of FIGS. 1 and 3A-D. In an embodiment, the process 600 may be performed by an AP, such as the AP 104 or the AP 304. At block 602, the process 600 receives a request for relay connection from a STA. In an embodiment, the STA has associated with the AP. At block 604, the process 600 transmits a message to at least one relay based on the received request for relay connection. In an embodiment, the message comprises an instruction to transmit a setup response frame to the STA. In a further embodiment, the setup response frame may be a TDLS response frame. In a further embodiment, the STA is configured to select one of the at least one relay based on at least one setup response frame received from at least one of the at least one relay. In a further embodiment, the STA is configured to transmit a setup confirm frame to the selected relay. In a further embodiment, the setup confirm frame is a TDLS confirm frame. In a further embodiment, the STA is configured to transmit information regarding the selected relay to the AP. After block 604, the process 600 ends.

FIG. 7 is a functional block diagram of an exemplary device 700 that may be employed within the wireless communication system 100, 300, and 350. The device 700 includes means 702 for receiving a request for relay connection from a STA. In an embodiment, means 702 for receiving a request for relay connection from a STA may be configured to perform one or more of the functions discussed above with respect to block 602. The device 700 further includes means 704 for transmitting a message to at least one relay based on the received request for relay connection. In an embodiment, means 704 for transmitting a message to at least one relay based on the received request for relay connection may be configured to perform one or more of the functions discussed above with respect to block 604.

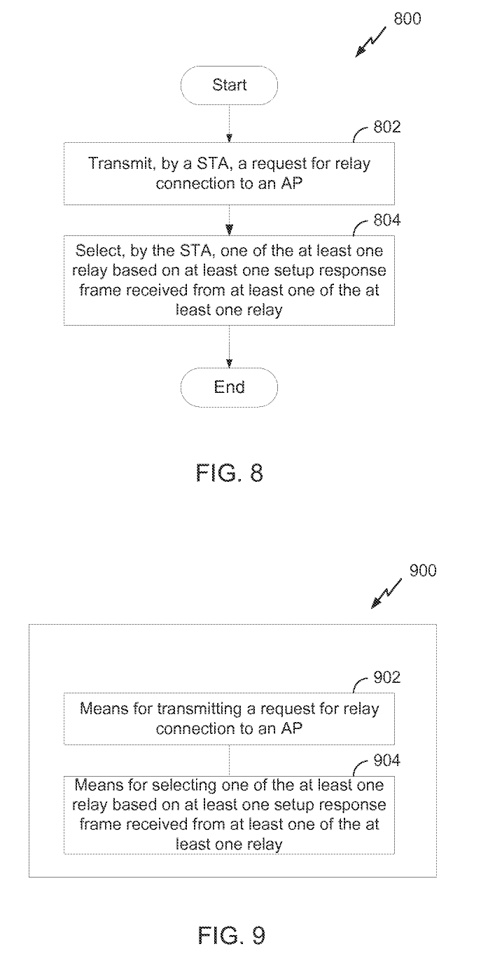

FIG. 8 is a flowchart of a process 800 for selecting a relay in the wireless communications system of FIGS. 1 and 3A-D. In an embodiment, the process 800 may be performed by a STA, such as the STA 106 or the STA 306. At block 802, the process 800 transmits a request for relay connection to an access point. In an embodiment, the access point is configured to transmit a message to at least one relay in response to the request for relay connection. In a further embodiment, the message comprises an instruction to transmit a setup response frame. At block 804, the process 800 selects one of the at least one relay based on at least one setup response frame received from at least one of the at least one relay. After block 804, the process 800 ends.

FIG. 9 is another functional block diagram of an exemplary device 900 that may be employed within the wireless communication system 100, 300, and 350. The device 900 includes means 902 for transmitting a request for relay connection to an access point. In an embodiment, means 902 for transmitting a request for relay connection to an access point may be configured to perform one or more of the functions discussed above with respect to block 802. The device 900 further includes means 904 for selecting one of the at least one relay based on at least one setup response frame received from at least one of the at least one relay. In an embodiment, means 904 for selecting one of the at least one relay based on at least one setup response frame received from at least one of the at least one relay may be configured to perform one or more of the functions discussed above with respect to block 804.

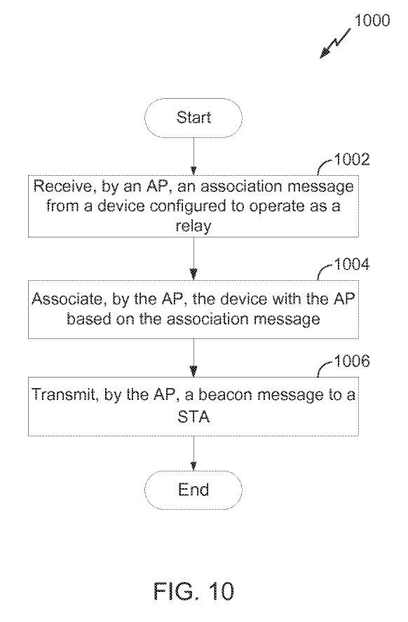

FIG. 10 is a flowchart of a process 1000 for registering a relay in the wireless communications system of FIGS. 1 and 3A-D. In an embodiment, the process 1000 may be performed by an AP, such as the AP 104 or the AP 304. At block 1002, the process 1000 receives an association message from a device configured to operate as a relay. In an embodiment, the association message comprises capabilities of the device and an indication of whether the device relays uplink traffic, downlink traffic, or both. At block 1004, the process 1000 associates the device with the AP based on the association message. At block 1006, the process 1000 transmits a beacon message to a STA. In an embodiment, the beacon message comprises an indication of whether the AP is associated with a relay. After block 1006, the process 1000 ends.

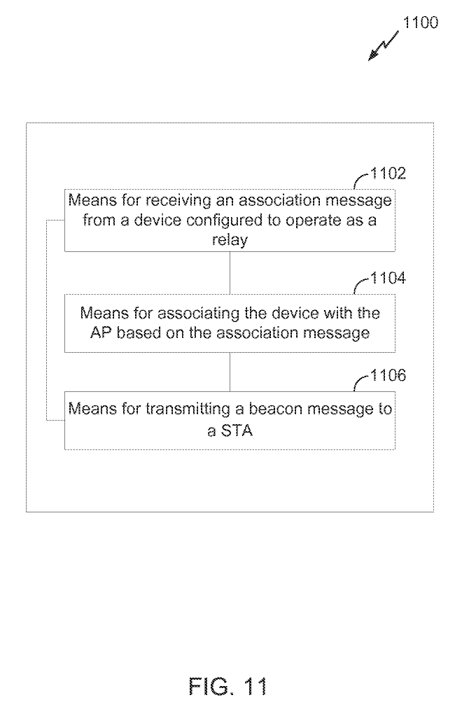

FIG. 11 is a functional block diagram of an exemplary device 1100 that may be employed within the wireless communication system 100, 300 and 350. The device 1100 includes means 1102 for receiving an association message from a device configured to operate as a relay. In an embodiment, means 1102 for receiving an association message from a device configured to operate as a relay may be configured to perform one or more of the functions discussed above with respect to block 1002. The device 1100 further includes means 1104 for associating the device with the AP based on the association message. In an embodiment, means 1104 for associating the device with the AP based on the association message may be configured to perform one or more of the functions discussed above with respect to block 1004. The device 1100 further includes means 1106 for transmitting a beacon message to a STA. In an embodiment, means 1106 for transmitting a beacon message to a STA may be configured to perform one or more of the functions discussed above with respect to block 1006.

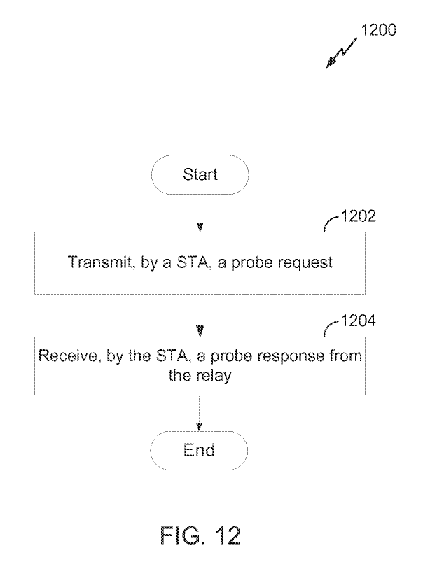

FIG. 12 is a flowchart of a process 1200 for discovering a wireless communications system of FIGS. 1 and 3A-D. In an embodiment, the process 1200 may be performed by a STA, such as the STA 106 or the STA 306. In an embodiment, the process 1200 may be utilized when a STA cannot communicate directly with an AP in order to associate with the AP. At block 1202, the process 1200 transmits a probe request. In an embodiment, the probe request is addressed to one of a wildcard SSID and a BSSID of a BSS in which a relay operates. At block 1204, the process 1200 receives a probe response from the relay. In an embodiment, the probe response comprises an identification of an AP the relay is associated with and capabilities of the relay. After block 1204, the process 1200 ends.

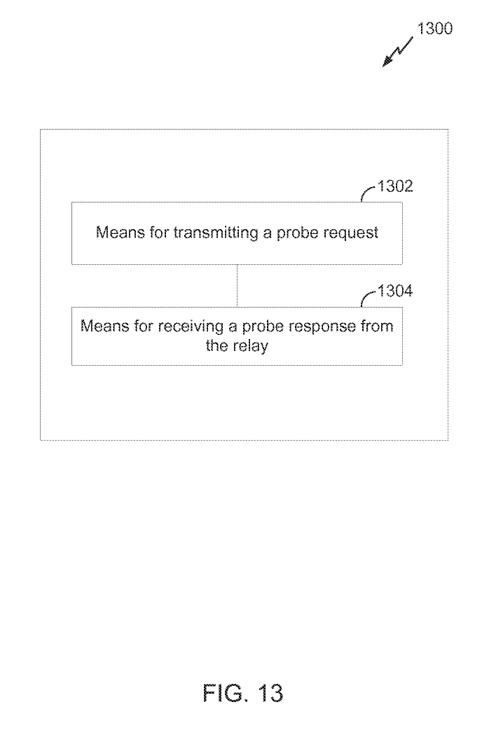

FIG. 13 is a functional block diagram of an exemplary device 1300 that may be employed within the wireless communication system 100, 300, and 350. The device 1300 includes means 1302 for transmitting a probe request. In an embodiment, means 1302 for transmitting a probe request may be configured to perform one or more of the functions discussed above with respect to block 1202. The device 1300 further includes means 1304 for receiving a probe response from the relay. In an embodiment, means 1304 for receiving a probe response from the relay may be configured to perform one or more of the functions discussed above with respect to block 1204.

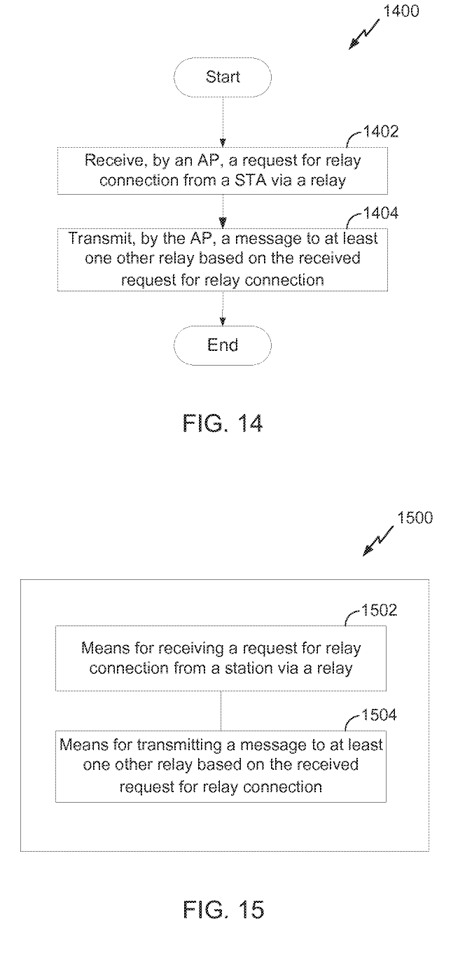

FIG. 14 is a flowchart of a process 1400 for selecting a relay in the wireless communications system of FIGS. 1 and 3A-D. In an embodiment, the process 1400 may be performed by an AP, such as the AP 104 or the AP 304. In an embodiment, the process 1400 may be utilized when a STA cannot communicate directly with an AP in order to associate with the AP. At block 1402, the process 1400 receives a request for relay connection from a STA via a relay. At block 1404, the process 1400 transmits a message to at least one other relay based on the received request for relay connection. In an embodiment, the message comprises an instruction to transmit a setup response frame to the STA. In a further embodiment, the setup response frame may be a TDLS response frame. In a further embodiment, the STA is configured to select one of the at least one other relay based on at least one setup response frame received from at least one of the at least one other relay. In a further embodiment, the STA is configured to transmit a setup confirm frame to the selected other relay. In a further embodiment, the setup confirm frame is a TDLS confirm frame. In addition, in some embodiments the selected other relay is the relay. In other embodiments, the selected other relay is different from the relay. In a further embodiment, the STA is configured to transmit information regarding the selected other relay to the relay. After block 1404, the process 1400 ends.

FIG. 15 is another functional block diagram of an exemplary device 1500 that may be employed within the wireless communication system 100, 300, and 350. The device 1500 includes means 1502 for receiving a request for relay connection from a STA via a relay. In an embodiment, means 1502 for receiving a request for relay connection from a STA via a relay may be configured to perform one or more of the functions discussed above with respect to block 1402. The device 1500 further includes means 1504 for transmitting a message to at least one other relay based on the received request for relay connection. In an embodiment, means 1504 for transmitting a message to at least one other relay based on the received request for relay connection may be configured to perform one or more of the functions discussed above with respect to block 1404.

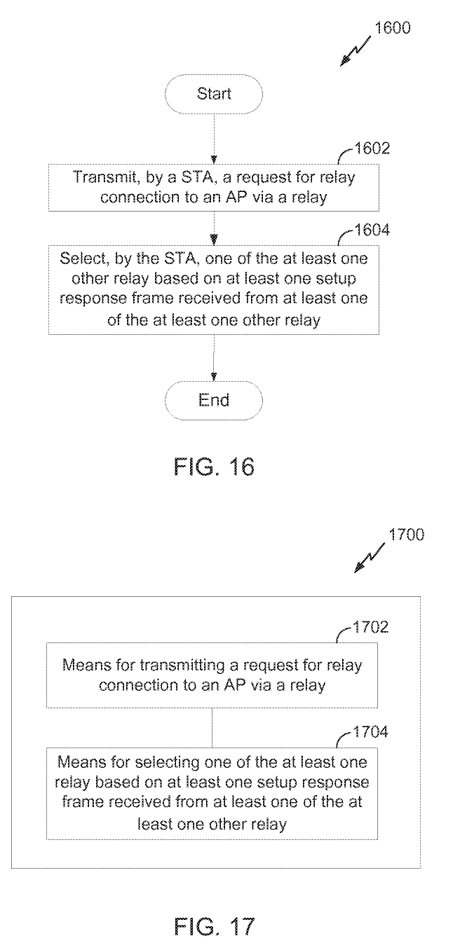

FIG. 16 is a flowchart of a process 1600 for selecting a relay in the wireless communications system of FIGS. 1 and 3A-D. In an embodiment, the process 1600 may be performed by a STA, such as the STA 106 or the STA 306. In an embodiment, the process 1600 may be utilized when a STA cannot communicate directly with an AP in order to associate with the AP. At block 1602, the process 1600 transmits a request for relay connection to an access point via a relay. In an embodiment, the access point is configured to transmit a message to at least one other relay in response to the request for relay connection. In a further embodiment, the message comprises an instruction to transmit a setup response frame. At block 1604, the process 1600 selects one of the at least one other relay based on at least one setup response frame received from at least one of the at least one other relay. After block 1604, the process 1600 ends.

FIG. 17 is another functional block diagram of an exemplary device 1700 that may be employed within the wireless communication system 100, 300, and 350. The device 1700 includes means 1702 for transmitting a request for relay connection to an access point via a relay. In an embodiment, means 1702 for transmitting a request for relay connection to an access point via a relay may be configured to perform one or more of the functions discussed above with respect to block 1602. The device 1700 further includes means 1704 for selecting one of the at least one other relay based on at least one setup response frame received from at least one of the at least one other relay. In an embodiment, means 1704 for selecting one of the at least one other relay based on at least one setup response frame received from at least one of the at least one other relay may be configured to perform one or more of the functions discussed above with respect to block 1604.

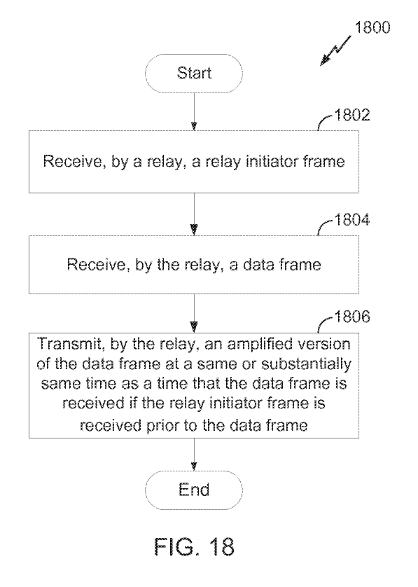

FIG. 18 is a flowchart of a process 1800 for communicating using an amplify and forward relay in the wireless communications system of FIGS. 1 and 3A-D. In an embodiment, the process 1800 may be performed by a relay, such as the relay 320 or the association relay 330. At block 1802, the process 1800 receives a relay initiator frame (RIF). At block 1804, the process 1800 receives a data frame. At block 1806, the process 1800 transmits an amplified version of the data frame at a same or substantially same time as a time that the data frame is received if the relay initiator frame is received prior to the data frame. After block 1806, the process 1800 ends.

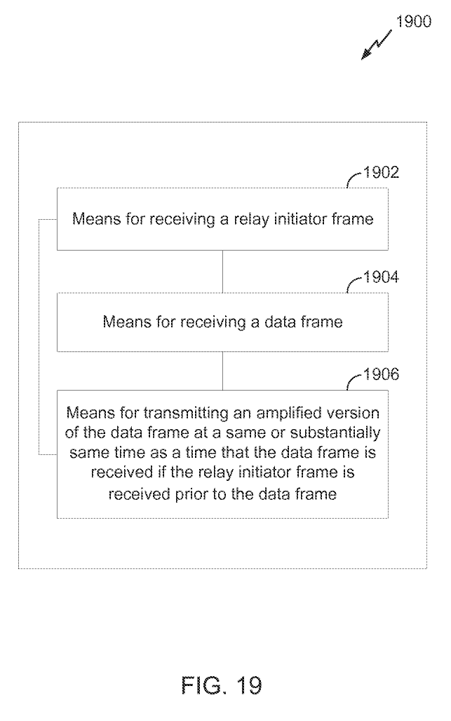

FIG. 19 is a functional block diagram of an exemplary device 1900 that may be employed within the wireless communication system 100, 300, and 350. The device 1900 includes means 1902 for receiving a relay initiator frame (RIF). In an embodiment, means 1902 for receiving a RIF may be configured to perform one or more of the functions discussed above with respect to block 1802. The device 1900 further includes means 1904 for receiving a data frame. In an embodiment, means 1904 for receiving a data frame may be configured to perform one or more of the functions discussed above with respect to block 1804. The device 1900 further includes means 1906 for transmitting an amplified version of the data frame at a same or substantially same time as a time that the data frame is received if the relay initiator frame is received prior to the data frame. In an embodiment, means 1906 for transmitting an amplified version of the data frame at a same or substantially same time as a time that the data frame is received if the relay initiator frame is received prior to the data frame may be configured to perform one or more of the functions discussed above with respect to block 1806.

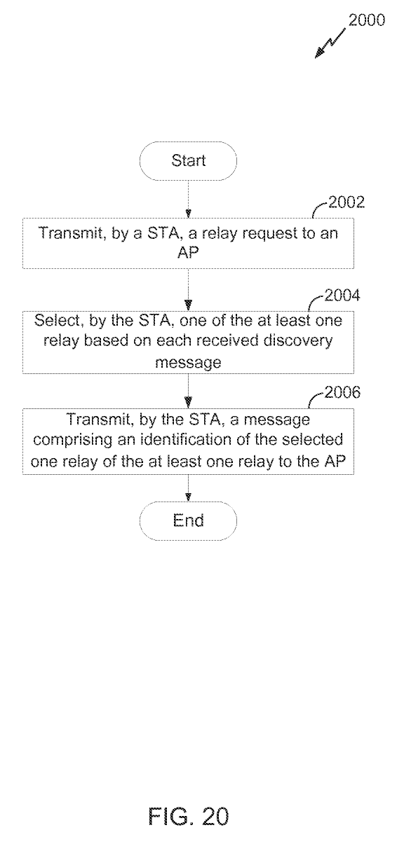

FIG. 20 is a flowchart of a process 2000 for setting up an amplify and forward relay in the wireless communications system of FIGS. 1 and 3A-D. In an embodiment, the process 2000 may be performed by a STA, such as the STA 106 or the STA 306. At block 2002, the process 2000 transmits a relay request to an AP. In an embodiment, the relay request may be transmitted by the STA to a store and forward relay, which then transmits it to the AP. In a further embodiment, the AP is configured to transmit a discovery request frame based on the relay request to at least one relay. In a further embodiment, each of the at least one relay is configured to transmit a discovery message based on the discovery request frame to the STA. At block 2004, the process 2000 selects one of the at least one relay based on each received discovery message. At block 2006, the process 2000 transmits a message comprising an identification of the selected one relay of the at least one relay to the AP. After block 2006, the process 2000 ends.

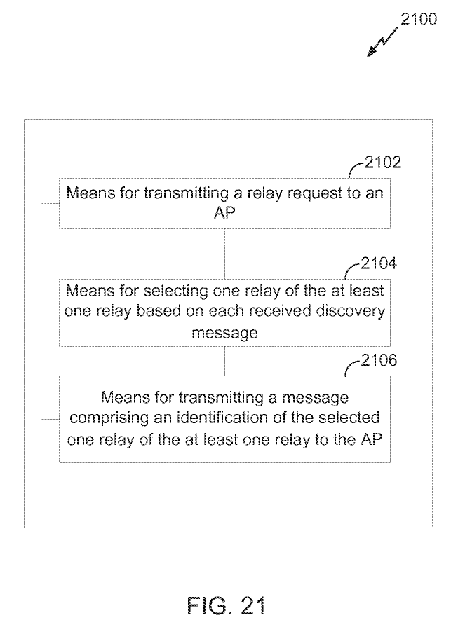

FIG. 21 is another functional block diagram of an exemplary device 2100 that may be employed within the wireless communication system 100, 300, and 350. The device 2100 include means 2102 for transmitting a relay request to an AP. In an embodiment, means 2102 for transmitting a relay request to an AP may be configured to perform one or more of the functions discussed above with respect to block 2002. The device 2100 further includes means 2104 for selecting one of the at least one relay based on each received discovery message. In an embodiment, means 2104 for selecting one of the at least one relay based on each received discovery message may be configured to perform one or more of the functions discussed above with respect to block 2004. The device 2100 further includes means 2106 for transmitting a message comprising an identification of the selected one relay of the at least one relay to the AP. In an embodiment, means 2106 for transmitting a message comprising an identification of the selected one relay of the at least one relay to the AP may be configured to perform one or more of the functions discussed above with respect to block 2006.

### Relay Discovery

In an embodiment, to discover a relay, such as relay 320, in the BSS, the STA 306 may transmit a relay discover frame request to the AP 304. The AP 304 may then forward the relay discovery request frame to one or more relays. As an example, the relay discovery request frame may be sent as a unicast message to the AP 304 (and may encapsulate a TDLS discovery request action frame), and the AP 304 may transmit the relay discovery request frame as a broadcast message to the one or more relays. The relay discovery request frame may comprise an information element that specifies features and/or specifications that the STA 306 is looking for in a relay 320. For example, the information element may specify whether the relay 320 should directly contact the STA 306 (e.g., as a public action frame with an action field described as a relay direct discovery response) or whether the relay 320 should contact the STA 306 via the AP 304 (e.g., as a TDLS frame with an action field described as a relay tunneled discovery response). In this way, the features and/or specification identified by the STA 306 may reduce a number of relays that respond to the relay discovery request frame broadcast by the AP 304.

In an embodiment, to enable the discovery of relays, two additional action fields may be added to a category of action frames known as TDLS action frames, which originally may include eleven action fields. The twelfth action field may define a (TDLS) relay discovery request, which may indicate that the STA 306 would like to discovery relays associated with the AP 304. The thirteenth action field may define a relay tunneled discovery response, which may indicate that the AP 304 should instruct the responding relays to contact the STA 306 via the AP 304 as described herein.

In addition, to enable the discovery of relays, one additional action field may be added to a category of action frames known as public action frames, which originally may include fifteen action fields. The sixteenth action field may define a relay direct discovery response, which may indicate that the responding relays should directly contact the STA 306 as described herein.

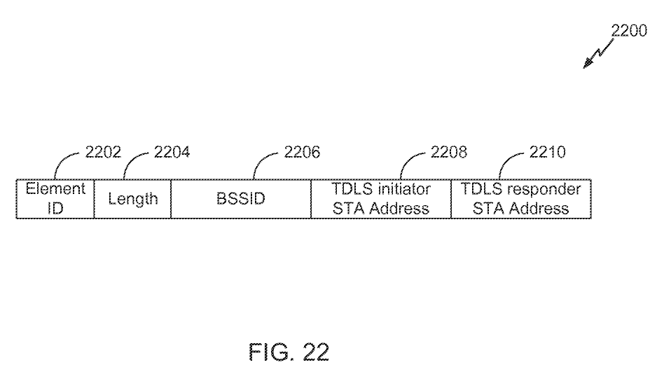

FIG. 22 illustrates a link identifier element 2200, which may be included in a relay discovery request frame such as may be transmitted by AP 304 and/or STA 306 as described herein. The link identifier element 1800 may include five fields: element ID 2202, length 2204, BSSID 2206, TDLS initiator STA address 2208, and TDLS responder STA address 2210. As an example, the element ID 2202 field may be 1 octet in length and may be used as is known in the art. Length 2204 field may be 1 octet in length and may be used as is known in the art. BSSID 2206 field may be 6 octets in length and may identify the AP 304 as described herein. The TDLS initiator STA address 2208 field may be 6 octets in length and may identify the STA 306 that initiated the relay discovery request. The TDLS responder STA address 2210 field may be 6 octets in length and may indicate a broadcast address, which may allow the STA 306 to specify that only relays need to respond to the relay discovery request frame. In addition, the broadcast address may be included in the third address field of the relay discovery request frame (e.g., address fields 364c and/or 374c, as described with respect to FIGS. 3B and 3D).

In this way, the link identifier element 2200 and at least one of the new action fields as described herein may be included in a relay discovery request frame to allow an AP 304 to broadcast a relay discovery request frame to one or more relays, instructing the relays if and how they should respond to the STA 306.

### Secure Range Extension

In some embodiments, as described herein, a STA 306 may operate in a BSS even if it has a poor connection with the AP 304 or cannot communicate with the AP 304 (e.g., because the AP 304 is beyond a radio range of the STA 306), or even if the AP 304 cannot communicate with the STA 306. As described herein, the STA 306 may be able to operate in the BSS through the use of a relay. In addition, the STA 306 may be able to securely associate with the AP 304 and establish a secure data connection with the AP 304 through the use of a relay.

In an embodiment, to allow a STA 306 to securely associate with the AP 304, an association frame and an authentication frame may be created. For example, for an association request frame and an association response frame, the address fields may be similar to those address fields described with respect to FIGS. 3B and/or 3D (e.g., the second address field (362b, 362d, 372b, and/or 372d) may carry an address of the relay, and the third address field (364a, 364b, 374a, and/or 374b) may carry the address of the AP 304). In addition, a fourth address field may be used for frames sent from the relay, such as relay 320 and/or association relay 330, to the AP 304 and from the relay, such as relay 320 and/or association relay 330, to the STA 306.

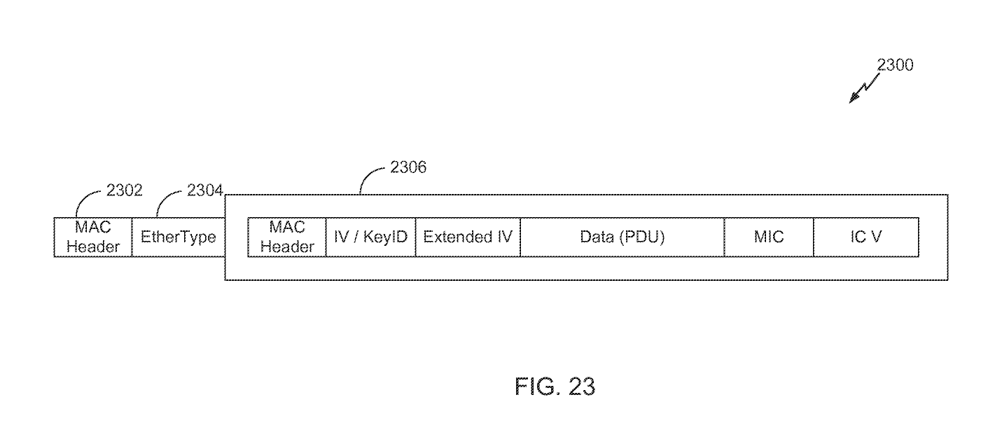

FIG. 23 illustrates a tunneled encrypted data frame 2300 that may be used to allow a STA 306 to establish a secure data connection with the AP 304. The tunneled encrypted data frame 2300 may comprise a MAC header 2302, an EtherType setting 2304, and a MAC protocol data unit (MPDU), such as encrypted MPDU 2306. For example, the encrypted MPDU 2306 may be an encrypted data MPDU and/or an encrypted management MPDU. In this way, an encrypted data frame may be inserted into the data frame of a packet.

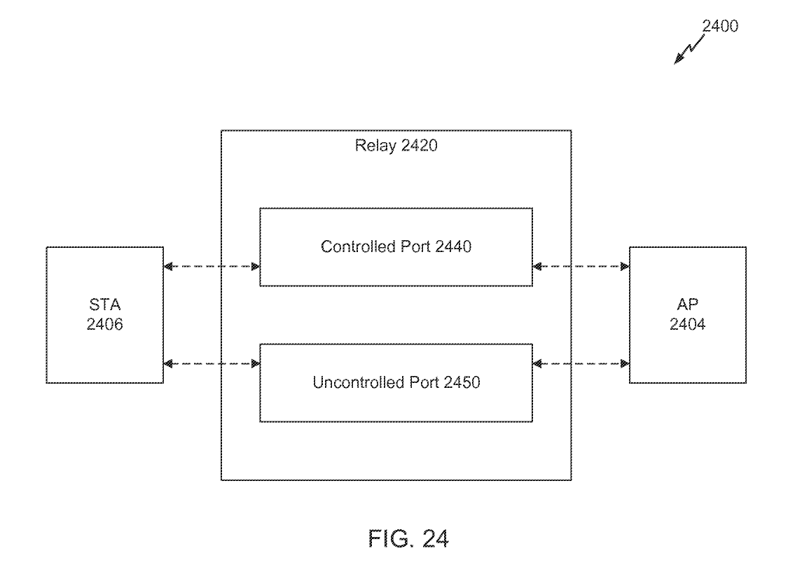

FIG. 24 illustrates a wireless communications system 2400. In an embodiment, wireless communications system 2400 includes an AP 2404, which may be similar to AP 304 of FIG. 3A, a STA 2406, which may be similar to the STA 306 of FIG. 3A, and/or relay 2420, which may be similar to relay 320 and/or association relay 330 of FIGS. 3A and 3C.

In an embodiment, relay 2420 may include a controlled port 2440 and an uncontrolled port 2450. If a (TDLS) relay relationship has been established between the STA 2406 and the relay 2420 using systems and processes as described herein, then data packets may be forwarded between the STA 2406 and the AP 2404 through the controlled port 2440 of the relay 2420. However, if the relay relationship has not been established or has been terminated, then data packets may not be forwarded between the STA 2406 and the AP 2404 through the controlled port 2440 of the relay 2420.

In some embodiments, even if no relay relationship has been established or it was terminated, the relay 2420 may still forward specific frames between the STA 2406 and the AP 2404 through the uncontrolled port 2450. For example, the uncontrolled port 2450 may be used to forward association frames, authentication frames, and/or tunneled encrypted data frames as described herein. In addition, the uncontrolled port 2450 may forward extensible authentication protocol over local area networks (EAPOL) frames.

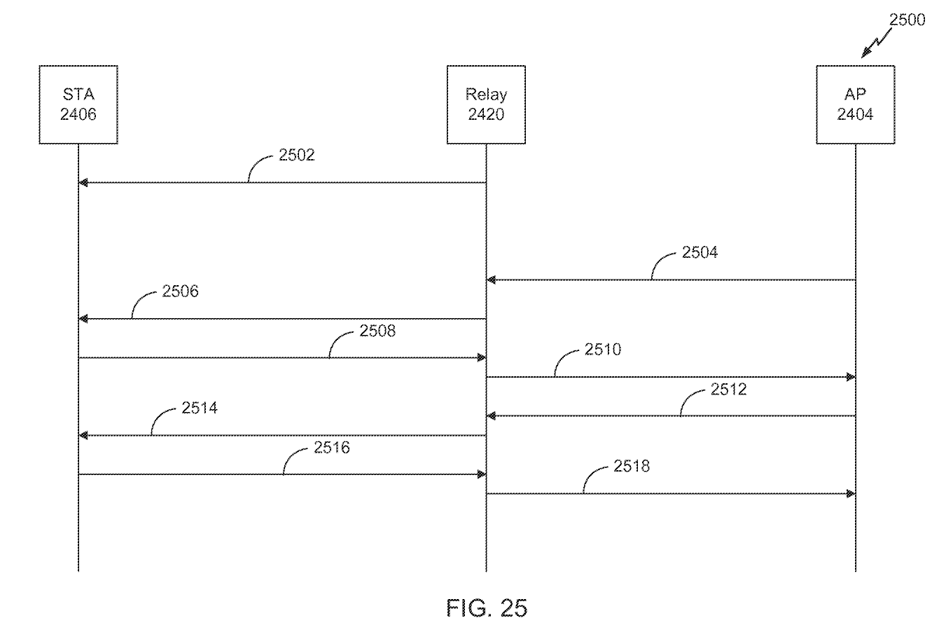

FIG. 25 illustrates a messaging timeline 2500 for frames that may be forwarded through the uncontrolled port 2450 of the relay 2420. For example, the relay 2420 may transmit a beacon and/or probe response 2502 to the STA 2406 in response to a beacon and/or probe request previously transmitted (not shown). In an embodiment, the AP 2404 may then attempt to verify credentials of the STA 2406 using an extensible authentication protocol (EAP) framework. For example, the AP 2404 may transmit an EAPOL key 2504 to the uncontrolled port 2450 of the relay 2420. The transmission may be a unicast transmission. The relay 2420 may then forward the EAPOL key 2506 to the STA 2406. Again, the transmission may be a unicast transmission. The STA 2406 may process the received EAPOL key 2506 and generate an encrypted EAPOL key 2508 and transmit it to the uncontrolled port 2450 of the relay 2420 via a unicast transmission. The relay 2420 may then forward the encrypted EAPOL key 2510 to the AP 2404 via a unicast transmission. The AP 2404 may process the received encrypted EAPOL key 2510 and generate an encrypted EAPOL key 2512 and transmit it to the uncontrolled port 2450 of the relay 2420 via a unicast transmission. The relay 2420 may then forward the encrypted EAPOL key 2514 to the STA 2406 via a unicast transmission. The STA 2406 may process the received encrypted EAPOL key 2514 and generate an EAPOL key 2516 and transmit it to the uncontrolled port 2450 of the relay 2420 via a unicast transmission. The relay 2420 may forward the EAPOL key 2518 to the AP 2404 via a unicast transmission. In some embodiments, the association and/or authentication may then be complete if no errors occur.

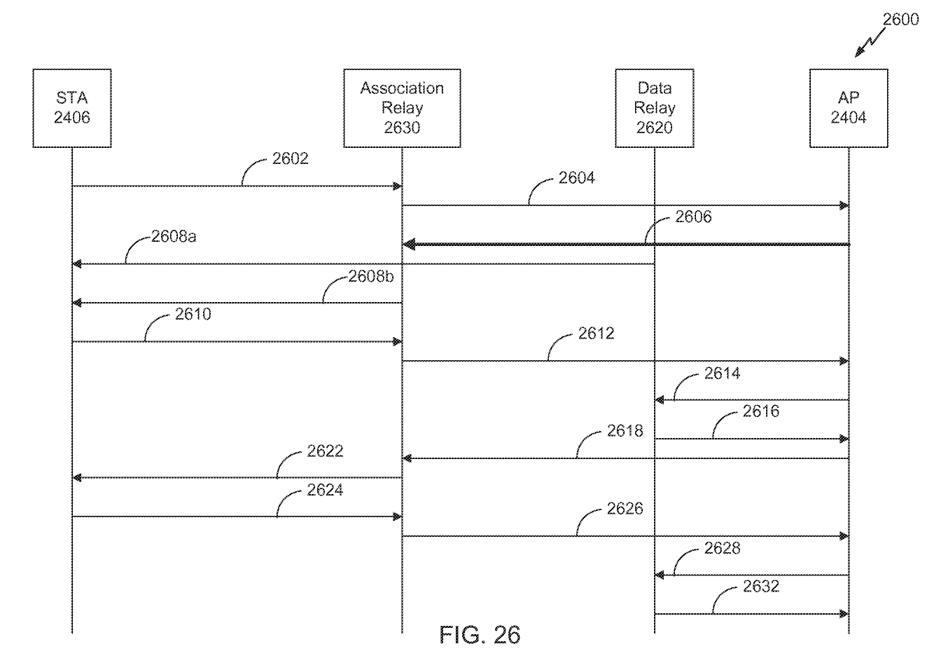

FIG. 26 illustrates another messaging timeline 2600 for frames that may be forwarded through the uncontrolled port 2450 of the relay 2420. The messaging timeline may include the AP 2404, the STA 2406, a data relay 2620, and/or an association relay 2630. In an embodiment, the data relay 2620 may be similar to the relay 320 of FIGS. 3A and 3C and the association relay 2630 may be similar to the relay 320 and/or the association relay 330 of FIG. 3C. As an example, the STA 2406 may wish to discovery relays associated with the AP 2404 and select at least one of the relays to forward data packets between the STA 2406 and the AP 2404. The STA 2406 may transmit a tunneled encrypted data packet (TEDP) (e.g., a tunneled encrypted data frame) relay (e.g., TDLS) discovery request frame 2602 to the uncontrolled port 2450 of the association relay 2630. The association relay 2630 may forward the TEDP relay discovery request frame 2604 to the AP 2404. The AP 2404 may analyze the received TEDP relay discovery request frame 2604 and transmit a TEDP relay discovery request frame 2606 to one or more relays, such as data relay 2620 and association relay 2630. In an embodiment, the TEDP discovery request frame 2606 is a broadcast message as described herein.

In some embodiments, data relay 2620 and association relay 2630 may both respond to the received TEDP relay discovery request frame 2606. The data relay 2620 may transmit the relay (e.g., TDLS) discovery response frame 2608a to the STA 2406 and the association relay 2630 may transmit the relay (e.g., TDLS) discovery response frame 2608b to the STA 2406. Alternatively, one or both of data relay 2620 and association relay 2630 may transmit their respective relay discovery response frame 2608a-b to the AP 2404, which may then forward the frame to the STA 2406. In other embodiments, not shown, data relay 2620 and/or association relay 2630 may not respond to the TEDP relay discovery request frame, for example based on the features and/or specifications desired by the STA 2406 as described herein.

Based on one or more received relay discovery response frames 2608a-b, the STA 2406 may choose a relay to relay packets between itself and the AP 2404 and transmit a TEDP TDLS setup request frame 2610 identifying the chosen relay as described herein to the AP 2404. In an embodiment, as illustrated in FIG. 26, the TEDP TDLS setup request frame 2610 may be forwarded to the AP 2404 via the uncontrolled port 2450 of the association relay 2630, which forwards a TEDP TDLS setup request frame 2612 to the AP 2404. As illustrated in FIG. 26, the STA 2406 has chosen the data relay 2620 as the selected relay. However, the STA 2406 may choose any relay, including the association relay 2630 as the selected relay.

The AP 2404 may analyze the received TEDP TDLS setup request frame 2612 and forward a TDLS setup request frame 2614 to the selected relay (in this case, the data relay 2620). In an embodiment, the TEDP TDLS setup request frame 2612 encapsulates the TDLS setup request frame 2614. If the selected relay approves the selection (e.g., it is capable of handling the STA 2406), the selected relay may transmit a TDLS setup response frame 2616 as described herein to the AP 2404. The AP 2404 may then forward the TDLS setup response frame 2616 as a TEDP TDLS setup response frame 2618 to the STA 2406 via the uncontrolled port 2450 of the association relay 2630 as TEDP TDLS setup response frame 2622. In an embodiment, the TEDP TDLS setup response frame 2618 encapsulates the TDLS setup response frame 2616. In other embodiments, the data relay 2620 may transmit the TEDP TDLS setup response frame 2616 directly to the STA 2406.

Based on the received TEDP TDLS setup response frame 2622, the STA 2406 may generate and transmit a TEDP TDLS setup confirm frame 2624 to the uncontrolled port 2450 of the association relay 2630, which then forward the TEDP TDLS setup confirm frame 2626 to the AP 2404. A TDLS setup confirm frame 2628, which may be encapsulated in the TEDP TDLS setup confirm frame 2626, may then be transmitted to the selected relay (in this case, the data relay 2620). At this point, a relay relationship between the STA 2406 and the data relay 2620 (the selected relay) may be established. The data relay 2620 (the selected relay) may register itself with the AP 2404 as a relay for the STA 2406 via message 2632. Once the relay relationship has been established, the data relay 2620 (the selected relay) may relay data packets between the STA 2406 and the AP 2404 via the controlled port 2440. In an embodiment, when the controlled port 2440 becomes active, the uncontrolled port 2450 may be deactivated.

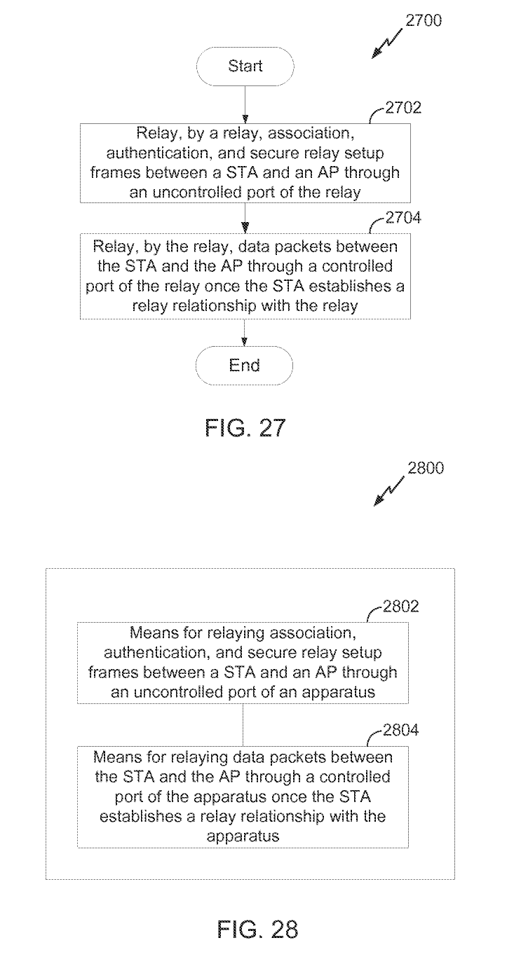

FIG. 27 is a flowchart of a process 2700 for securely communication data in a wireless communications system of FIGS. 1, 3A-D, and 2400. In an embodiment, the process 2700 may be utilized when a STA cannot communicate directly with an AP. At block 2702, the process 2700 relays, by a relay, association, authentication, and secure relay setup frames between a STA and an AP through an uncontrolled port of the relay. At block 2704, the process 2700 relays, by the relay, data packets between the STA and the AP through a controlled port of the relay once the STA establishes a relay relationship with the relay. In an embodiment, if a relay relationship is established, the uncontrolled port of the relay may be deactivated. After block 2704, the process 2700 ends.

FIG. 28 is a functional block diagram of an exemplary device 2800 that may be employed within the wireless communication system 100, 300, 350, and 2400. The device 2800 includes means 2802 for relaying association, authentication, and secure relay setup frames between a STA and an AP through an uncontrolled port of an apparatus. In an embodiment, means 2802 for relaying association, authentication, and secure relay setup frames between a STA and an AP through an uncontrolled port of an apparatus may be configured to perform one or more of the functions discussed above with respect to block 2702. The device 2800 further includes means 2804 for relaying data packets between the STA and the AP through a controlled port of the apparatus once the STA establishes a relay relationship with the apparatus. In an embodiment, means 2804 for relaying data packets between the STA and the AP through a controlled port of the apparatus once the STA establishes a relay relationship with the apparatus may be configured to perform one or more of the functions discussed above with respect to block 2704.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A system for securely communicating data, the system comprising:
a station configured to communicate with an access point; and
a relay comprising an uncontrolled port and a controlled port, wherein the relay is configured to forward association, authentication, and secure relay setup frames between the station and the access point through the uncontrolled port, and wherein the relay is configured to forward data packets between the station and the access point through the controlled port once the station establishes a relay relationship with the relay.

2. The system of claim 1, further comprising a data relay and an association relay, wherein the association relay comprises an uncontrolled port and a controlled port, and wherein the data relay comprises an uncontrolled port and a controlled port.

3. The system of claim 2, wherein the association relay is configured to prevent a forward of any packets from the station or the access point through the controlled port unless a relay relationship between the station and the association relay is established, and wherein the data relay is configured to prevent a forward of any packets from the station or the access point through the controlled port unless a relay relationship between the station and the data relay is established.

4. The system of claim 2, wherein the station is further configured to associate with the access point by transmitting outgoing extensible authentication protocol over local area networks (EAPOL) messages to the access point and receiving incoming EAPOL messages from the access point, wherein the outgoing and incoming EAPOL messages are forwarded through the uncontrolled port of the association relay.

5. The system of claim 2, wherein the station is further configured to establish a relay relationship with the data relay based on a transmission of secure discovery frames to the access point through the uncontrolled port of the association relay and a reception of secure discovery frames from the access point through the uncontrolled port of the association relay, wherein the data relay is configured to relay data packets between the station and the access point through the controlled port once the relay relationship is established.

6. The system of claim 5, wherein the station is further configured to transmit a relay discovery request frame via a unicast transmission, and wherein the access point is further configured to transmit a relay discovery request frame via a broadcast transmission.

7. The system of claim 5, wherein the station is further configured to establish the relay relationship with the data relay based on a transmission of secure relay setup frames to the access point through the uncontrolled port of the association relay and a reception of relay setup frames from the access point through the uncontrolled port of the association relay.

8. The system of claim 7, wherein the secure discovery frames are tunneled encrypted data packet (TEDP) tunneled direct link setup (TDLS) discovery frames, and wherein the secure relay setup frames are TEDP TDLS relay setup frames.

9. The system of claim 8, wherein the TEDP comprises a media access control (MAC) header, an ethertype field, and an encrypted MAC protocol data unit (MPDU).

10. A method for securely communicating data, the method comprising:
relaying, by a relay, association, authentication, and secure relay setup frames between a station and an access point through an uncontrolled port of the relay; and
relaying, by the relay, data packets between the station and the access point through a controlled port of the relay once the station establishes a relay relationship with the relay.

11. The method of claim 10, further comprising preventing, by the relay, a forward of any packets from the station or the access point through the controlled port unless the relay relationship between the station and the relay is established.

12. The method of claim 10, further comprising associating, by the station, with the access point by transmitting outgoing extensible authentication protocol over local area networks (EAPOL) messages to the access point and receiving incoming EAPOL messages from the access point, wherein the outgoing and incoming EAPOL messages are forwarded through the uncontrolled port of the relay.

13. The method of claim 10, further comprising establishing, by the station, the relay relationship with the relay based on a transmission of secure discovery frames to the access point through the uncontrolled port of the relay and a reception of secure discovery frames from the access point through the uncontrolled port of the relay.

14. The method of claim 13, further comprising:
transmitting, by the station, a relay discovery request frame via a unicast transmission; and
transmitting, by the access point, a relay discovery request frame via a broadcast transmission.

15. The method of claim 13, wherein the establishing further comprises establishing the relay relationship with the relay based on a transmission of secure relay setup frames to the access point through the uncontrolled port of the relay and a reception of relay setup frames from the access point through the uncontrolled port of the relay.

16. The method of claim 15, wherein the establishing further comprises establishing the relay relationship with the relay based on the transmission and reception of tunneled encrypted data packet (TEDP) tunneled direct link setup (TDLS) discovery frames and based on the transmission and reception of TEDP TDLS relay setup frames, wherein the TEDP comprises a media access control (MAC) header, an ethertype field, and an encrypted MAC protocol data unit (MPDU).

17. An apparatus for securely communicating data, the apparatus comprising:
means for relaying association, authentication, and secure relay setup frames between a station and an access point through an uncontrolled port of the apparatus; and
means for relaying data packets between the station and the access point through a controlled port of the apparatus once the station establishes a relay relationship with the apparatus.

18. The apparatus of claim 17, further comprising means for preventing a forward of any packets from the station or the access point through the controlled port unless the relay relationship between the station and the apparatus is established.

19. The apparatus of claim 17, wherein the station is configured to associate with the access point by transmitting outgoing extensible authentication protocol over local area networks (EAPOL) messages to the access point and receiving incoming EAPOL messages from the access point, wherein the outgoing and incoming EAPOL messages are forwarded through the uncontrolled port of the apparatus.

20. The apparatus of claim 17, wherein the station is configured to establish the relay relationship with the apparatus based on a transmission of secure discovery frames to the access point through the uncontrolled port of the apparatus and a reception of secure discovery frames from the access point through the uncontrolled port of the apparatus.

21. The apparatus of claim 20, further comprising:
means for receiving, from the station, a relay discovery request frame via a unicast transmission; and
means for receiving, from the access point, a relay discovery request frame via a broadcast transmission.

22. The apparatus of claim 20, wherein the relay relationship is establish with the apparatus based on a transmission of secure relay setup frames to the access point through the uncontrolled port of the apparatus and a reception of relay setup frames from the access point through the uncontrolled port of the apparatus.

23. The apparatus of claim 22, wherein the relay relationship is established with the apparatus based on the transmission and reception of tunneled encrypted data packet (TEDP) tunneled direct link setup (TDLS) discovery frames and based on the transmission and reception of TEDP TDLS relay setup frames, wherein the TEDP comprises a media access control (MAC) header, an ethertype field, and an encrypted MAC protocol data unit (MPDU).

24. The apparatus of claim 17, wherein the means for relaying association, authentication, and secure relay setup frames and the means for relaying data packets comprise a relay.

25. A non-transitory computer-readable medium comprising code that, when executed, causes an apparatus to:
relay association, authentication, and secure relay setup frames between a station and an access point through an uncontrolled port of the apparatus; and
relay data packets between the station and the access point through a controlled port of the apparatus once the station establishes a relay relationship with the relay.

26. The medium of claim 25, further comprising code that, when executed, causes the apparatus to prevent a forward of any packets from the station or the access point through the controlled port unless the relay relationship between the station and the apparatus is established.

27. The medium of claim 25, further comprising code that, when executed, causes the apparatus to facilitate association between the station and the access point by forwarding extensible authentication protocol over local area networks (EAPOL) messages between the station and the access point, wherein the EAPOL messages are forwarded through the uncontrolled port of the apparatus.

28. The medium of claim 25, further comprising code that, when executed, causes the apparatus to establish the relay relationship with the station based on a transmission by the station of secure discovery frames to the access point through the uncontrolled port of the apparatus and a reception by the station of secure discovery frames from the access point through the uncontrolled port of the apparatus.

29. The medium of claim 28, further comprising code that, when executed, causes the apparatus to:
receive, from the station, a relay discovery request frame via a unicast transmission; and
receive, from the access point, a relay discovery request frame via a broadcast transmission.

30. The medium of claim 28, further comprising code that, when executed, causes the apparatus to establish the relay relationship with the station based on a transmission by the station of secure relay setup frames to the access point through the uncontrolled port of the apparatus and a reception by the station of relay setup frames from the access point through the uncontrolled port of the apparatus.

31. The medium of claim 30, further comprising code that, when executed, causes the apparatus to establish the relay relationship with the station based on the transmission and reception by the station of tunneled encrypted data packet (TEDP) tunneled direct link setup (TDLS) discovery frames and based on the transmission and reception by the station of TEDP TDLS relay setup frames, wherein the TEDP comprises a media access control (MAC) header, an ethertype field, and an encrypted MAC protocol data unit (MPDU).
